(19) United States
(12) Patent Application Publication
(10) Pub. No.: US 2012/0094038 A1
(43) Pub. Date: Apr. 19, 2012

(54) USE OF HUMIDITY STABLE YELLOW FLUORESCENT PIGMENTS IN SECURITY APPLICATIONS

(75) Inventors: Thomas R. Potrawa, Seelze (DE); Michael Kessler, Neustadt (DE)

(73) Assignee: HONEYWELL INTERNATIONAL INC., Morristown, NJ (US)

(21) Appl. No.: 13/246,692

(22) Filed: Sep. 27, 2011

Related U.S. Application Data
(60) Provisional application No. 61/392,794, filed on Oct. 13, 2010.

(51) Int. Cl. B42D 15/00; B42D 15/10; C09B 57/00

(52) U.S. Cl. 428/29; 544/289; 283/92

(57) ABSTRACT

Yellow and yellow-green fluorescent compounds are provided herein that can be incorporated into carriers (e.g., inks) and applied (e.g., printed) as security features on substrates (e.g., documents). The compounds can be selected based upon their resistance to humidity, and preferably exhibit a high initial fluorescence intensity, and a relatively high fluorescence intensity as well as a low relative intensity loss after prolonged humidity exposure.

### RELATED APPLICATION

This application claims priority to co-pending, U.S. Provisional Application Ser. No. 61/392,794, filed on Oct. 13, 2010.

### FIELD OF THE INVENTION

The present disclosure relates to the use, as security elements in carriers (e.g., inks, pigments, coatings, or paints), of fluorescent yellow and yellow-green pigments that exhibit stability under conditions of high humidity.

### DESCRIPTION OF RELATED ART

Colored organic fluorescent pigments such as Lumilux® CD 397 and CD 302 (available from Honeywell International Inc.) have been used as security features in inks that are printed on labels or value documents such as banknotes, cheques, shares, passports, visas, identity documents and the like in order to make the counterfeiting of these products more difficult. Generally, such pigments are used in providing covert security features, which are not detectable by the human eye under normal daylight conditions, but become detectable when they absorb radiation having a specific wavelength.

Existing yellow and yellow-green fluorescent compounds and methods of making such were disclosed in U.S. Pat. No. 3,169,129 to Rodgers et al., which is incorporated herein in its entirety.

### SUMMARY OF THE INVENTION

Methods of producing an applied (e.g., printed) security feature on a substrate (e.g., a portion of an identification card, a driver's license, a passport, identity papers, a banknote, a check, a document, a paper, a stock certificate, a packaging component, a credit card, a bank card, a label, a seal, a postage stamp, a token, a liquid, a human, an animal, and a biological sample) are provided herein that employ carriers with fluorescent pigments, and in particular yellow or yellow-green fluorescent pigments.

In one aspect, a method is provided that includes selecting a yellow fluorescent pigment that has a fluorescence intensity selecting a fluorescent pigment that has a fluorescence intensity loss of less than about 40 percent of an initial intensity when excited by light having a wavelength of about 365 nm, after the fluorescent pigment has been subjected to exposure to a temperature of at least 85° C. and a relative humidity of 100% for a time period of at least about 40 hours, wherein the initial intensity is an absolute fluorescence intensity of the fluorescent pigment prior to the exposure. The method further includes making a carrier (e.g., an ink, pigment, coating, or paint) that comprises the yellow fluorescent pigment, and incorporating (e.g., printing, coating, spraying, adhering, bonding, or embedding) the carrier and pigment onto or into a substrate (e.g., a portion of an identification card, a driver's license, a passport, identity papers, a banknote, a check, a document, a paper, cardstock, a film, a stock certificate, a packaging component, a credit card, a bank card, a label, a seal, a postage stamp, a token, a liquid, a human, an animal, or a biological sample). The yellow fluorescent pigment preferably has an initial absolute fluorescence intensity of greater than about 100 cd/m² when excited by light having a wavelength of 365 nm.

### BRIEF DESCRIPTION OF THE DRAWINGS

Specific examples have been chosen for purposes of illustration and description, and are shown in the accompanying drawings, forming a part of the specification.

FIG. 1 is a plot of the measured, absolute fluorescence intensities versus time of various test samples.

FIG. 2 is a plot of the relative intensity over time of each test sample.

### DETAILED DESCRIPTION

Fluorescent compounds, particularly yellow and yellow-green fluorescent compounds, and methods of using such compounds as security features are provided herein. In some examples, a fluorescent compound can be incorporated into a carrier (e.g., an ink (such as an offset ink), pigment, coating, or paint), and can be applied or incorporated (e.g., printed, coated, sprayed, adhered, bonded, or embedded) onto or into a substrate to form a security feature.

The substrate into or onto which a security feature is incorporated that includes a fluorescent compound of the present technology can be any suitable substrate. In some examples, the substrate can be a paper, cardstock, a film, a plastic, or other substrates. In other examples, the security feature may be incorporated onto or into a human, an animal, a biological specimen, a liquid sample, and virtually any other object or material into or onto which a fluorescent compound of an embodiment may be applied or included. Security features using fluorescent compound of the present technology can, for example, be particularly useful for value documents. For example, the fluorescent compounds can be printed in any desired pattern onto a value document, and can thus be a covert security feature that can be used to authenticate the value document. Alternatively, the fluorescent compounds can be incorporated into a material comprising a substrate (e.g., paper pulp, plastic base resin, and so on) or into a security thread or other component that is embedded within the substrate. Value documents tend to be publicly handled, and can thus be subjected to harsh conditions, including temperature swings and extremes, and high humidity. Accordingly, in order to retain the effectiveness of the covert feature, fluorescent compounds of the present technology are created and selected to be more stable than currently available products under conditions of high humidity and temperature. The fluorescent compounds of the present technology exhibit higher resistance to humidity than other fluorescent compounds.

As used herein, fluorescence refers to the emission of light energy of one or a plurality of wavelengths by a compound when that compound is excited by light energy of a different wavelength, usually lower, from a light source.

Preferably, the fluorescent compounds exhibit little or no visible color when exposed to white light, but fluoresce when subjected to ultraviolet light. In some examples, the fluorescent compounds fluoresce yellow or yellow-green. In some examples, fluorescent compounds of the present technology can have an initial fluorescence intensity of greater than about 100 candelas per square meter (cd/m²) when excited by light having a wavelength of about 365 nanometers (nm). Preferably, the fluorescent compounds have an initial fluorescence intensity from about 100 cd/m² to about 130 cd/m² when excited by light having a wavelength of about 365 nm, from about 110 cd/m² to about 125 cd/m² when excited by light having a wavelength of about 365 nm, or from about 115 cd/m² to about 125 cd/m² when excited by light having a wavelength of about 365 nm.

Fluorescent compounds of the present technology can be selected to exhibit resistance to humidity. For example, a fluorescent compound of the present technology may have a fluorescence intensity of greater than 80 cd/m² when excited by light having a wavelength of about 365 nm after being exposed to a temperature of at least 85° C. and a relative humidity of 100% for a time period of at least 40 hours, and preferably has such a fluorescence intensity after such exposure for a time period of at least about 80 hours. In one example, a fluorescent compound of the present technology may have a fluorescence intensity of greater than 90 cd/m² when excited by light having a wavelength of about 365 nm after being exposed to a temperature of at least 85° C. and a relative humidity of 100% for a time period of at least about 40 hours, and preferably has such a fluorescence intensity after such exposure for a time period of at least about 80 hours.

Overall, fluorescent compounds of the present technology preferably exhibit a low level of relative intensity loss after prolonged exposure to high humidity levels. Relative intensity loss is the percentage by which the initial intensity value decreases over time due to the exposure. For example, a fluorescent compound of the present technology may have a relative intensity loss of less than about 10% after being exposed to a temperature of 85° C. and a relative humidity of 100% for a time period of at least 20 hours. Preferably, a fluorescent compound of the present technology may have a relative intensity loss of less than about 20% after being exposed to a temperature of 85° C. and a relative humidity of 100% for a time period of at least 40 hours, and more preferably exhibits a relative intensity loss of less than about 20% after being exposed to a temperature of 85° C. and a relative humidity of 100% for a time period of at least 80 hours.

Some fluorescent compounds of the present technology can be generally represented by the formula:

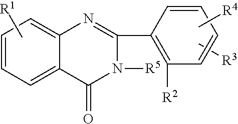

wherein R¹, R², R³ and R⁴ each represent hydrogen or a substituent such as halogen, hydroxyl, an alkyl or alkoxy of 1-4 carbons; and R⁵ represents hydrogen or an alkyl of 1-4 carbons. Such compounds can be prepared by known general methods of synthesis such as those disclosed in U.S. Pat. No. 3,169,129.

For example, one method of preparing such compounds can be accomplished by a reaction of an aroyl anilide with urethane (ethyl ester of aminoformic acid) in the presence of phosphorus pentoxide. This may be illustrated by the following reaction scheme:

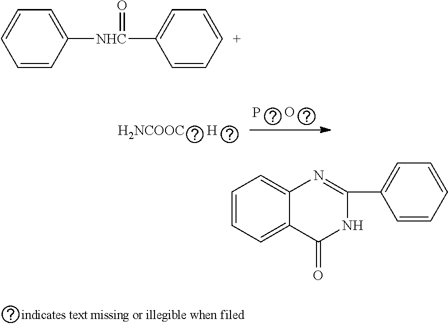

Although yields by this method generally are not as high as might be desired, this method affords a procedure for obtaining various substituted derivatives from more readily available or more easily prepared starting materials. Thus, by choosing appropriately substituted anilides, the desired substituted quinazolones may be prepared. Illustrative aroyl anilides which may be used in this method include:
p-Anisanilide
4′-butyl-p-anisanilide
4′-chloro-p-anisanilide
4′-bromo-p-anisanilide
4′-methyl-p-anisanilide
Benzanilide
4″-methylbenzanilide
4″-chlorobenzanilide
2′-chlorobenzandlide
p-Benzanisidide
p-Anis-o-anisidide
p-Anis-p-anisidide
4,4′-dichlorobenzanilide
2,4′-dichlorobenzanilide
2-methyl-4′-chlorobenzanilide
2-methyl-4′-butylbenzanilide

Another method of preparing such compounds can be accomplished by a reaction of an anthranilamide with an aromatic aldehyde by heating in the presence of a solvent, such as ethanol, to give an anil type compound which then can be ring closed to a dihydroquinazolone in the presence of caustic, and the dihydroquinazolone can then be oxidized to the corresponding quinazolone. This may be illustrated by the following reaction scheme:

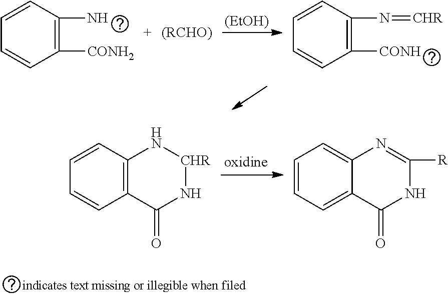

This procedure also may be used to obtain substituted derivatives by using appropriately substituted starting materials. Illustrative anthranilamides, for example, include those having chloro- or bromo-substituents in the 4- or the 5-position. Illustrative aldehydes include, for example:
Benzaldehyde
o-Anisaldehyde
p-Anisaldehyde
m-Anisaldehyde
2,4-dimethoxybenzaldehyde
2-chlorobenzaldehyde
4-chlorobenzaldehyde
4-bromobenzaldehyde

A third method of preparing such compounds can be accomplished by cyclization of N-aroyl anthranilamides under alkaline conditions as illustrated in the following reaction scheme:

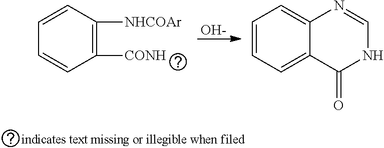

Here again substituted derivatives may be prepared by having appropriate substituents in the starting materials.

Preferred fluorescent compounds of the present technology that can be prepared in accordance with the methods described above are 2-(2-hydroxyphenyl)-4(3)-quinazolones. For example, a particularly preferred fluorescent compound of the present technology is 2-(3,5-dichloro-2-hydroxyphenyl)-4(3)-quinazolone, which fluoresces yellow or yellow-green when excited by light having a wavelength of about 365 nm.

### Example 1

### Production of 2-(3,5-dichloro-2-hydroxyphenyl)-4(3)-quinazolone

One half mol (103.5 g) of 3,5-dichlorosalicylic acid, thionyl chloride (150 cc), pyridine (0.5 cc) are stirred for 3 hours at a temperature from about 30° C. to about 40° C. Excess SOCl₂ is removed by vacuum distillation below 40° C. The resulting acid chloride is added over a period of one-half hour to a mixture of anthranilamide (55 g) and anhydrous potassium carbonate (70 g) in benzene (200 cc) and diethyl ether (450 g). The mixture is stirred overnight and then treated with 5% aqueous sodium hydroxide (1400 cc). The reaction mixture is heated to a temperature of about 90° C. for one hour, cooled and neutralized with acetic acid. The 2-(3,5-dichloro-2-hydroxyphenyl)-4(3)-quinazolone is collected by filtration and recrystallized from phenol.

### Example 2

### Humidity Testing

Several yellow and yellow-green fluorescent compounds were pre-milled with a three roll mill (e.g., an EXAKT 80E three roll mill manufactured by Exakt Technologies, Inc. of Oklahoma City, Okla.) in order to normalize particle distribution, and each pre-milled compound was made into an offset ink by combining 30% by weight of the compound in alkyd resin. The inks were printed as stripes onto optical brightener free paper with 1 g ink/m² (0.3 g pigment/m²) via a test printer (e.g., an IGT C1 printability tester manufactured by IGT Testing Systems of Amsterdam, Netherlands). The printed inks were allowed to dry for two days at room temperature. The initial, absolute fluorescence intensities of the printed inks were measured by excitation under about 365 nm with a luminance meter (e.g., an LS-100 Luminance Meter manufactured by Konica Minolta Sensing Inc. of Ramsey, N.J.) in cd/m², and the printed inks were then tested under high humidity conditions.

The printed inks were then subjected to exposure to a temperature of 85° C. and a relative humidity of 100% for 80 hours, and their absolute fluorescent intensities were measured throughout the period of exposure. Specifically, the printed inks were placed into an exsiccator charged with some water at the bottom in order to achieve 100% relative humidity. The exsiccator was heated by an oven for a total time period of 80 hours at a temperature of 85° C. The fluorescence intensities of the printed inks were periodically determined by excitation under about 365 nm with a Minolta Luminance Meter LS-100 in cd/m².

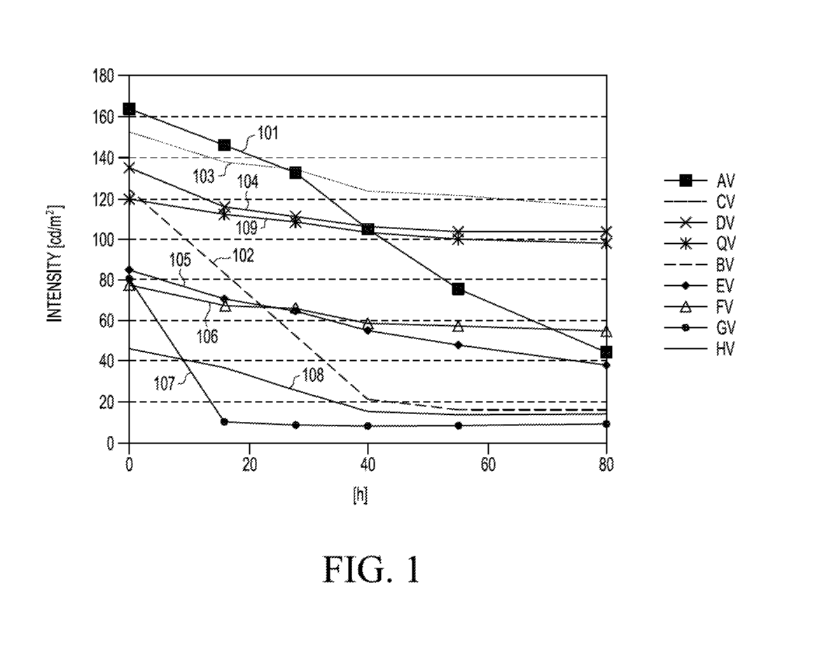

The measured, absolute fluorescence intensities of a plurality of different samples (designated as AV 101, BV 102, CV 103, DV 104, EV 105, FV 106, GV 107, HV 108, and QV 109) over the period of exposure (specified in hours, [h]) are provided in FIG. 1. The intensity measurements over time were made using the same equipment and the same excitation conditions. The sample labeled DV 104 was 2-(5-chloro-2-hydroxyphenyl)-4(3)-quinazolone, the sample labeled FV 106 was 2-(2-hydroxyphenyl)-4(3)-quinazolone, and the sample labeled QV 109 was 2-(3,5-dichloro-2-hydroxyphenyl)-4(3)-quinazolone. As shown in FIG. 1, sample DV 104 had an initial absolute intensity, prior to the exposure, of about 135 cd/m², and a final absolute intensity, after 80 hours of exposure, of about 105 cd/m². Sample FV 106 had an initial absolute intensity, prior to the exposure, of about 77 cd/m², and a final absolute intensity, after 80 hours of exposure, of about 54 cd/m². Sample QV 109 had an initial absolute intensity, prior to the exposure, of about 120 cd/m², and a final absolute intensity, after 80 hours of exposure, of about 98 cd/m².

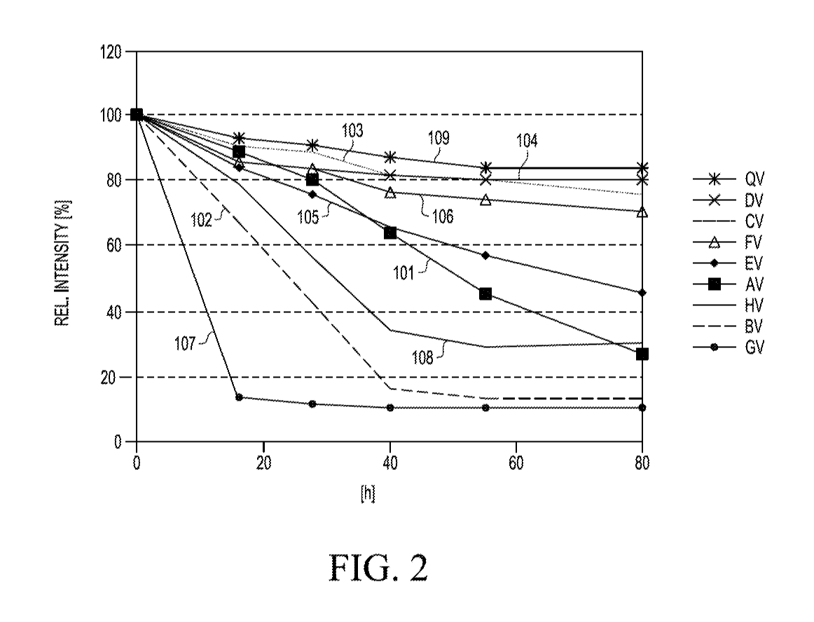

The relative intensity (i.e., the intensity at time [h]×(100/initial intensity)) of each sample was calculated, and the relative intensities of the various samples (again designated as AV 101, BV 102, CV 103, DV 104, EV 105, FV 106, GV 107, HV 108, and QV 109) over the period of exposure (specified in hours, [h]) are shown in FIG. 2. The intensity measurements over time, upon which the relative intensity values were based, were made using the same equipment and the same excitation conditions. As shown in FIG. 2, after 80 hours of exposure, sample QV 109 had a fluorescence intensity loss of less than 20 percent of its initial intensity (i.e., the absolute fluorescence intensity of the fluorescent pigment prior to the exposure) when excited by light having a wavelength of about 365 nm.

According to an embodiment, a fluorescent pigment is selected for use with a substrate, which has an initial absolute fluorescence intensity of greater than about 100 cd/m² when excited by light having a wavelength of about 365 nm (e.g., an initial absolute fluorescence intensity in a range of about 100 cd/m² to about 130 cd/m²). According to the results depicted in FIG. 1, samples AV 101, BV 102, CV 103, DV 104, and QV 109 meet this criterion. However, as will be explained below, the selection of the fluorescent pigment may be such that the fluorescent pigment also is characterized by a relatively low percentage of absolute intensity loss after exposure to relatively high temperatures and humidity (e.g., accelerated environmental exposure).

More specifically, according to an embodiment, a fluorescent pigment is selected for use with a substrate, which has a fluorescence intensity loss of less than about 20 percent of its initial intensity when excited by light having a wavelength of about 365 nm, after the fluorescent pigment has been subjected to exposure to a temperature of at least 85° C. and a relative humidity of 100% for a time period of at least about 40 hours. According to the results depicted in FIG. 2, samples QV 109, CV 103, and DV 104 meet this criterion. According to another embodiment, a fluorescent pigment is selected for use with a substrate, which has a fluorescence intensity loss of less than about 20 percent of its initial intensity when excited by light having a wavelength of about 365 nm, after the fluorescent pigment has been subjected to exposure to a temperature of at least 85° C. and a relative humidity of 100% for a time period of at least about 80 hours. According to the results depicted in FIG. 2, samples QV 109 and DV 104 meet this criterion.

In still other embodiments, a fluorescent pigment is selected for use with a substrate, which has a fluorescence intensity loss of less than about 40 percent of its initial intensity when excited by light having a wavelength of about 365 nm, after the fluorescent pigment has been subjected to exposure to a temperature of at least 85° C. and a relative humidity of 100% for a time period of at least about 40 hours. According to the results depicted in FIG. 2, samples QV 109, AV 101, CV 103, DV 104, EV 105, and FV 106 meet this criterion. In still other embodiments, a fluorescent pigment is selected for use with a substrate, which has a fluorescence intensity loss of less than about 40 percent of its initial intensity when excited by light having a wavelength of about 365 nm, after the fluorescent pigment has been subjected to exposure to a temperature of at least 85° C. and a relative humidity of 100% for a time period of at least about 80 hours. According to the results depicted in FIG. 2, samples QV 109, CV 103, DV 104, and FV 106 meet this criterion.

### Example 3

### Chemical Resistance

It was also unexpectedly discovered that 2-(3,5-dichloro-2-hydroxyphenyl)-4(3)-quinazolone exhibits good resistance properties when exposed to numerous normally degrading chemicals.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A method of producing a printed security feature on a document, the method comprising the steps of:
selecting a fluorescent pigment that has a fluorescence intensity loss of less than about 40 percent of an initial intensity when excited by light having a wavelength of about 365 nm, after the fluorescent pigment has been subjected to exposure to a temperature of at least 85° C. and a relative humidity of 100% for a time period of at least about 40 hours, wherein the initial intensity is an absolute fluorescence intensity of the fluorescent pigment prior to the exposure;
making an ink that comprises the fluorescent pigment; and
printing the ink onto a document.

2. The method of claim 1, wherein the fluorescent pigment has a fluorescence intensity loss of less than about 40 percent of the initial intensity when excited by light having a wavelength of about 365 nm after being exposed to a temperature of at least 85° C. and a relative humidity of 100% for a time period of at least 80 hours.

3. The method of claim 1, wherein the fluorescent pigment has a fluorescence intensity loss of less than about 20 percent of the initial intensity when excited by light having a wavelength of about 365 nm after being exposed to a temperature of at least 85° C. and a relative humidity of 100% for a time period of at least 40 hours.

4. The method of claim 3, wherein the fluorescent pigment has a fluorescence intensity loss of less than about 20 percent of the initial intensity when excited by light having a wavelength of about 365 nm after being exposed to a temperature of at least 85° C. and a relative humidity of 100% for a time period of at least 80 hours.

5. The method of claim 1, wherein the fluorescent pigment has an initial absolute fluorescence intensity of greater than about 100 cd/m² when excited by light having a wavelength of about 365 nm.

6. The method of claim 5, wherein the fluorescent pigment has an initial absolute fluorescence intensity from about 100 cd/m² to about 130 cd/m² when excited by light having a wavelength of about 365 nm.

7. The method of claim 1, wherein the fluorescent pigment is a 2-(5-chloro-2-hydroxyphenyl)-4(3)-quinazolone.

8. The method of claim 1, wherein the fluorescent pigment is 2-(3,5-dichloro-2-hydroxyphenyl)-4(3)-quinazolone.

9. A security feature comprising a fluorescent pigment that has a fluorescence intensity loss of less than about 40 percent of an initial intensity when excited by light having a wavelength of about 365 nm, after the fluorescent pigment has been subjected to exposure to a temperature of at least 85° C. and a relative humidity of 100% for a time period of at least about 40 hours, wherein the initial intensity is an absolute fluorescence intensity of the fluorescent pigment prior to the exposure.

10. The security feature of claim 9, wherein the fluorescent pigment has a fluorescence intensity of loss of less than about 40 percent of the initial intensity when excited by light having a wavelength of about 365 nm after being exposed to a temperature of at least 85° C. and a relative humidity of 100% for a time period of at least 80 hours.

11. The security feature of claim 9, wherein the fluorescent pigment has a fluorescence intensity loss of less than about 20 percent of the initial intensity when excited by light having a wavelength of about 365 nm after being exposed to a temperature of at least 85° C. and a relative humidity of 100% for a time period of at least 40 hours.

12. The security feature of claim 11, wherein the fluorescent pigment has a fluorescence intensity loss of less than about 20 percent of the initial intensity when excited by light having a wavelength of about 365 nm after being exposed to a temperature of at least 85° C. and a relative humidity of 100% for a time period of at least 80 hours.

13. The security feature of claim 9, wherein the fluorescent pigment has an initial absolute fluorescence intensity from about 100 cd/m² to about 130 cd/m² when excited by light having a wavelength of about 365 nm.

14. The security feature of claim 9, wherein the fluorescent pigment is a 2-(2-hydroxyphenyl)-4(3)-quinazolone.

15. The security feature of claim 14, wherein the fluorescent pigment is 2-(3,5-dichloro-2-hydroxyphenyl)-4(3)-quinazolone.

16. The security feature of claim 9, wherein the security feature is incorporated with a document.

17. An article comprising:
a substrate; and
a security feature that includes a fluorescent pigment with a fluorescence intensity loss of less than about 40 percent of an initial intensity when excited by light having a wavelength of about 365 nm, after the fluorescent pigment has been subjected to exposure to a temperature of at least 85° C. and a relative humidity of 100% for a time period of at least about 40 hours, wherein the initial intensity is an absolute fluorescence intensity of the fluorescent pigment prior to the exposure.

18. The article of claim 17, wherein the fluorescent pigment comprises a 2-(3,5-dichloro-2-hydroxyphenyl)-4(3)-quinazolone.

19. The article of claim 17, wherein the substrate comprises a substrate selected from a group consisting of paper, cardstock, a film, and a plastic.

20. The article of claim 17, wherein the security feature comprises a security feature selected from a group consisting of a printed security feature and an embedded security feature.
